(19) United States
(12) Patent Application Publication
(10) Pub. No.: US 2026/0050491 A1
(43) Pub. Date: Feb. 19, 2026

(54) ASSIGNMENT OF HIGH-PERFORMANCE WORKLOADS TO COMPUTE NODES IN A CLUSTER

(71) Applicant: Kratos Integral Holdings LLC, San Diego, CA (US)

(72) Inventors: Gage Hainer, Bulls Gap, TN (US); Jeff Jarriel, Colorado Springs, CO (US); Anthony Semiao, Purcellville, VA (US)

(21) Appl. No.: 18/808,319

(22) Filed: Aug. 19, 2024

(51) Int. Cl. G06F 9/50; G06F 9/48

(52) U.S. Cl. CPC G06F 9/5083; G06F 9/4881

(57) ABSTRACT

Described herein are systems, methods, and other techniques for assigning high-performance workloads to compute nodes in a compute infrastructure. The workloads are received at a workload scheduler. Each workload of the workloads includes a workload specification indicating requested resources to run the workload. Server statuses indicating resource usages and availabilities at the compute nodes are generated by a set of server agents running on a set of servers containing the compute nodes. The server statuses are sent from the set of server agents to the workload scheduler. Server assignments for the workloads are generated by the workload scheduler based on the requested resources and the resource usages and availabilities. Compute node assignments for the workloads are generated by one or more of the set of server agents based on the requested resources and the resource usages and availabilities.

### BACKGROUND OF THE INVENTION

Distributed systems, such as those used in cloud computing architectures, can enhance the processing capabilities of satellite communication systems by leveraging robust infrastructure and scalable resources. In a satellite communication system, a significant amount of data is transmitted from satellites orbiting the Earth to ground stations. Traditionally, this process requires extensive on-ground infrastructure for data processing and storage, which can be costly and inflexible. By integrating cloud computing, these high-performance workloads can be offloaded to cloud servers, where they benefit from advanced processing power and elastic storage capabilities. This integration enables real-time data analysis and processing for applications such as communications, weather forecasting, and telemetry analysis, without the need for extensive physical infrastructure at the ground station. Moreover, cloud computing systems facilitate improved data sharing between different entities and regions by providing a centralized platform accessible from anywhere in the world.

### SUMMARY OF THE INVENTION

A summary of the various embodiments of the invention is provided below as a list of examples. As used below, any reference to a series of examples is to be understood as a reference to each of those examples disjunctively (e.g., "Examples 1-4" is to be understood as "Examples 1, 2, 3, or 4").

Example 1 is a method of assigning a set of workloads to compute nodes in a compute infrastructure, the method comprising: receiving, at a workload scheduler, the set of workloads to be run on the compute nodes, each workload of the set of workloads having a workload specification indicating requested resources to run the workload; generating, by a set of server agents running on a set of servers containing the compute nodes, server statuses indicating resource usages and availabilities at the compute nodes; sending the server statuses from the set of server agents to the workload scheduler; generating, by the workload scheduler, server assignments for the set of workloads based on the requested resources and the resource usages and availabilities; generating, by one or more of the set of server agents, compute node assignments for the set of workloads based on the requested resources and the resource usages and availabilities; and running the set of workloads on the compute nodes in accordance with the server assignments and the compute node assignments.

Example 2 is the method of example(s) 1, wherein the workload specification indicates at least one of: a processor request indicating a number of processors or cores requested for the workload; a memory request indicating an amount of memory requested for the workload; a network interface card (NIC) bandwidth request indicating an amount of NIC bandwidth requested for the workload; or a memory bandwidth memory request indicating an amount of memory bandwidth requested for the workload.

Example 3 is the method of example(s) 1-2, wherein each of the server statuses indicates at least one of: a processor availability at a compute node of a corresponding server; a memory availability at the compute node; a network interface card (NIC) bandwidth availability at the compute node; or a memory bandwidth availability at the compute node.

Example 4 is the method of example(s) 1-3, wherein the workload specification indicates a grouping ID, wherein workloads having a same grouping ID are attempted to be assigned to a same compute node.

Example 5 is the method of example(s) 1-4, wherein: generating the server assignments for the set of workloads includes assigning a first workload, a second workload, and a third workload of the set of workloads to a first server of the set of servers; generating the compute node assignments for the set of workloads includes assigning the first workload and the second workload to a first compute node of the first server and assigning the third workload to a second compute node of the first server; and the workload specification for each of the first workload, the second workload, and the third workload indicates a same grouping ID.

Example 6 is the method of example(s) 1-5, wherein the set of workloads are virtual network function (VNF) workloads.

Example 7 is the method of example(s) 1-6, wherein each of the set of servers includes at least two of the compute nodes.

Example 8 is the method of example(s) 1-7, wherein the compute infrastructure is a cluster consisting of the set of servers.

Example 9 is a non-transitory computer-readable medium comprising instructions that, when executed by one or more processors, cause the one or more processors to perform operations for assigning a set of workloads to compute nodes in a compute infrastructure, the operations comprising: receiving, at a workload scheduler, the set of workloads to be run on the compute nodes, each workload of the set of workloads having a workload specification indicating requested resources to run the workload; generating, by a set of server agents running on a set of servers containing the compute nodes, server statuses indicating resource usages and availabilities at the compute nodes; sending the server statuses from the set of server agents to the workload scheduler; generating, by the workload scheduler, server assignments for the set of workloads based on the requested resources and the resource usages and availabilities; generating, by one or more of the set of server agents, compute node assignments for the set of workloads based on the requested resources and the resource usages and availabilities; and running the set of workloads on the compute nodes in accordance with the server assignments and the compute node assignments.

Example 10 is the non-transitory computer-readable medium of example(s) 9, wherein the workload specification indicates at least one of: a processor request indicating a number of processors or cores requested for the workload; a memory request indicating an amount of memory requested for the workload; a network interface card (NIC) bandwidth request indicating an amount of NIC bandwidth requested for the workload; or a memory bandwidth memory request indicating an amount of memory bandwidth requested for the workload.

Example 11 is the non-transitory computer-readable medium of example(s) 9-10, wherein each of the server statuses indicates at least one of: a processor availability at a compute node of a corresponding server; a memory availability at the compute node; a network interface card (NIC) bandwidth availability at the compute node; or a memory bandwidth availability at the compute node.

Example 12 is the non-transitory computer-readable medium of example(s) 9-11, wherein the workload specification indicates a grouping ID, wherein workloads having a same grouping ID are attempted to be assigned to a same compute node.

Example 13 is the non-transitory computer-readable medium of example(s) 9-12, wherein: generating the server assignments for the set of workloads includes assigning a first workload, a second workload, and a third workload of the set of workloads to a first server of the set of servers; generating the compute node assignments for the set of workloads includes assigning the first workload and the second workload to a first compute node of the first server and assigning the third workload to a second compute node of the first server; and the workload specification for each of the first workload, the second workload, and the third workload indicates a same grouping ID.

Example 14 is the non-transitory computer-readable medium of example(s) 9-13, wherein the set of workloads are virtual network function (VNF) workloads.

Example 15 is a system comprising: one or more processors; and a computer-readable medium comprising instructions that, when executed by the one or more processors, cause the one or more processors to perform operations for assigning a set of workloads to compute nodes in a compute infrastructure, the operations comprising: receiving, at a workload scheduler, the set of workloads to be run on the compute nodes, each workload of the set of workloads having a workload specification indicating requested resources to run the workload; generating, by a set of server agents running on a set of servers containing the compute nodes, server statuses indicating resource usages and availabilities at the compute nodes; sending the server statuses from the set of server agents to the workload scheduler; generating, by the workload scheduler, server assignments for the set of workloads based on the requested resources and the resource usages and availabilities; generating, by one or more of the set of server agents, compute node assignments for the set of workloads based on the requested resources and the resource usages and availabilities; and running the set of workloads on the compute nodes in accordance with the server assignments and the compute node assignments.

Example 16 is the system of example(s) 15, wherein the workload specification indicates at least one of: a processor request indicating a number of processors or cores requested for the workload; a memory request indicating an amount of memory requested for the workload; a network interface card (NIC) bandwidth request indicating an amount of NIC bandwidth requested for the workload; or a memory bandwidth memory request indicating an amount of memory bandwidth requested for the workload.

Example 17 is the system of example(s) 15-16, wherein each of the server statuses indicates at least one of: a processor availability at a compute node of a corresponding server; a memory availability at the compute node; a network interface card (NIC) bandwidth availability at the compute node; or a memory bandwidth availability at the compute node.

Example 18 is the system of example(s) 15-17, wherein the workload specification indicates a grouping ID, wherein workloads having a same grouping ID are attempted to be assigned to a same compute node.

Example 19 is the system of example(s) 15-18, wherein: generating the server assignments for the set of workloads includes assigning a first workload, a second workload, and a third workload of the set of workloads to a first server of the set of servers; generating the compute node assignments for the set of workloads includes assigning the first workload and the second workload to a first compute node of the first server and assigning the third workload to a second compute node of the first server; and the workload specification for each of the first workload, the second workload, and the third workload indicates a same grouping ID.

Example 20 is the system of example(s) 15-19, wherein the set of workloads are virtual network function (VNF) workloads.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates an example compute infrastructure comprising a set of compute nodes for running a set of workloads.

FIG. 2 illustrates example communications between server agents and a workload scheduler within a compute infrastructure.

FIG. 3 illustrates example server and compute node assignments for a set of workloads that are to run on a compute infrastructure.

FIG. 4 illustrates an example server agent.

FIG. 5 illustrates an example method performed by a plugin running on a server of a compute infrastructure.

FIG. 6 illustrates an example communication path between end points enabled by a satellite communication system.

FIG. 7 illustrates an example satellite communication system including a gateway and a set of terminals.

FIG. 8 illustrates an example method of assigning a set of workloads to compute nodes in a compute infrastructure.

FIG. 9 illustrates an example computer system comprising various hardware elements.

In the appended figures, similar components and/or features may have the same numerical reference label. Further, various components of the same type may be distinguished by following the reference label with a letter or by following the reference label with a dash followed by a second numerical reference label that distinguishes among the similar components and/or features. If only the first numerical reference label is used in the specification, the description is applicable to any one of the similar components and/or features having the same first numerical reference label, irrespective of the suffix.

### DETAILED DESCRIPTION OF THE INVENTION

In a satellite communication system, a compute infrastructure may consist of clusters of servers running high-performance workloads generated by satellite operations. These clusters allow for the distribution of computational tasks across multiple servers, enhancing the system's ability to handle large volumes of data transmitted from satellites, such as communications data, telemetry data, and scientific measurements. Clusters can scale dynamically, adjusting the number of active servers based on the incoming data volume and computational demands, which is particularly useful during peak times when satellites transmit higher data loads. As such, the compute infrastructure of a satellite communication system can enhance performance, scalability, and fault tolerance, leading to more robust and responsive satellite operations.

Software elements running on the compute infrastructure may orchestrate placement of incoming workloads onto the compute infrastructure’s compute nodes. These software elements may include a workload scheduler and a number of server agents, collectively forming the compute infrastructure’s control plane. The server agents may provide information to the workload scheduler on central processing unit (CPU) and memory availability for each physical server in a cluster. This allows the workload scheduler to select a number of servers that can run the workload when a number of CPUs and amount of memory is requested to run the workload. The workload scheduler may select the server with the most available resources and the server agent running on the selected server may run the workload on the compute node with the most available processors and memory.

Conventional approaches to workload scheduling in a cluster are non-deterministic, i.e., the placement of a workload cannot be determined beforehand. While this limitation is not an issue for many applications, for high-performance workloads such as virtual network function (VNF) workloads for a satellite communication system, a non-deterministic placement is not ideal. This is primarily due to two factors. First, the conventional scheduling technique may only consider CPU and memory usage. However, high-performance network function workloads (such as software modems, signal analyzers, etc.) may also need to consider memory bandwidth (the amount of data that can be passed per unit time between the physical processor and memory), the network bandwidth consumed on the network interface card (NIC), CPU speed and capabilities, the physical topology relative to analog equipment, the availability of high-speed disks for recording when compute resources are non-homogenous, etc. Furthermore, network function workloads may need to be grouped together on the same compute node for performance efficiencies and for optimum use of resources such as CPU and memory.

Embodiments of the present disclosure relate to systems and methods for assigning workloads to servers and compute nodes in a deterministic manner and based on a complete view of the availability of the physical resources on the servers and compute nodes. Before assigning workloads to servers, the workload scheduler may receive a server status from each server agent indicating resource usages and availabilities at the compute nodes. This status may indicate the NIC bandwidth and memory bandwidth availability at each of the server’s compute nodes. The workload scheduler considers the information in each server status along with the resource requests specified by the workloads to make a scheduling decision. When the scheduled workloads arrive at a server, the server agent again considers the bandwidth and memory bandwidth availability along with any grouping requests specified by the workloads to assign the workloads to compute nodes.

Many benefits are achieved by way of the present disclosure. For example, by considering NIC bandwidth and memory bandwidth when making assignments to compute nodes, the performance of high-performance workloads such as network function workloads is improved. In many cases, such workloads consume significant NIC bandwidth because they are driving user data through the physical network interface and significant memory bandwidth because of the rates that data is processed during packet processing operations and radio digital signal processing (DSP) and forward error correction (FEC) computations. Assigning workloads based on NIC and memory bandwidths prevents overdriving the limits of the servers and avoids poor performance, loss of data, and service down time. Embodiments additional allow deterministic grouping of network function workloads on the same compute node, allowing for optimum CPU usage and avoiding “noisy” neighbor issues that may impact processing done by other network functions. Optimum CPU usage also improves cost effectiveness since the number of unused processors is minimized.

In the following description, various examples will be described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

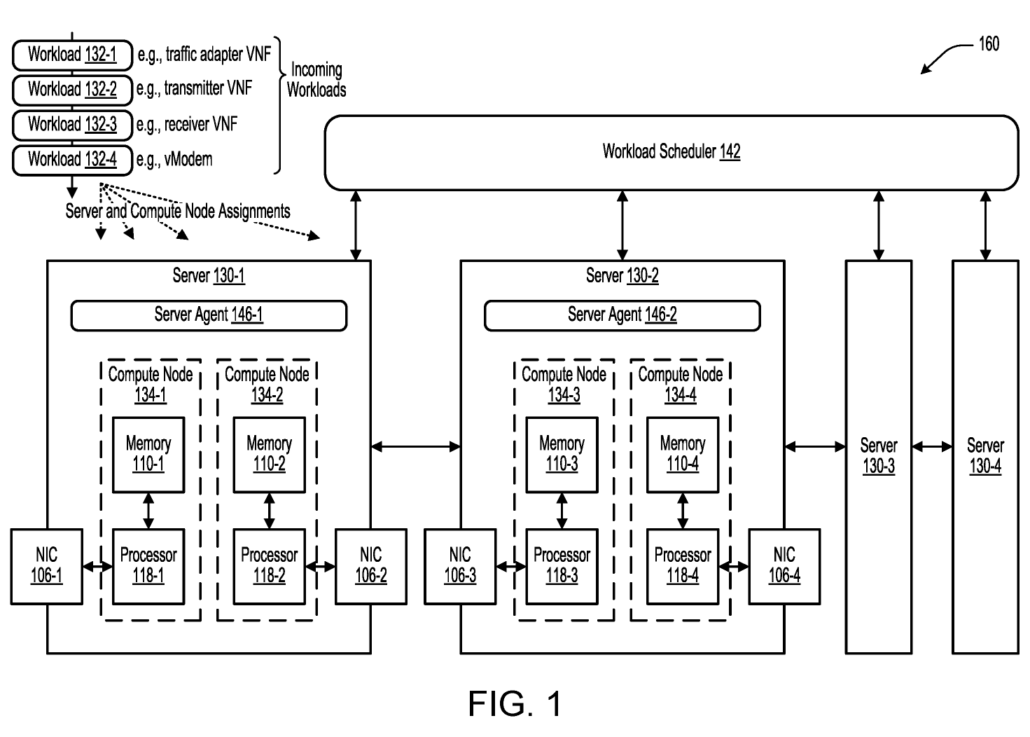

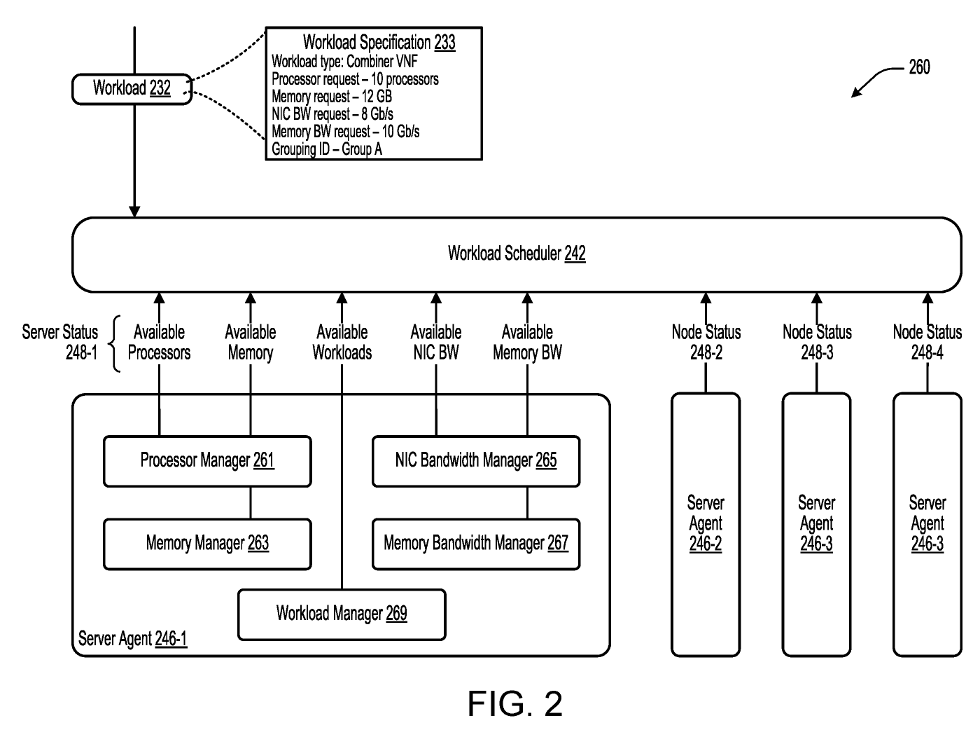

The figures herein follow a numbering convention in which the first digit or digits correspond to the figure number and the remaining digits identify an element or component in the figure. Similar elements or components between different figures may be identified by the use of similar digits. For example, 108 may reference element “08” in FIG. 1, and a similar element may be referenced as 208 in FIG. 2. As will be appreciated, elements shown in the various embodiments herein can be added, exchanged, and eliminated so as to provide a number of additional embodiments of the present disclosure. In addition, the proportion and the relative scale of the elements provided in the figures are intended to illustrate certain embodiments of the present disclosure and should not be taken in a limiting sense.

FIG. 1 illustrates an example compute infrastructure 160 comprising a set of compute nodes 134 for running a set of workloads 132, in accordance with some embodiments of the present disclosure. In some examples, compute infrastructure 160 may correspond to a cluster of a cloud computing architecture having a set of servers 130. Each of servers 130 may include one or more compute nodes 134 connected to one or more NICs 106. Each of compute nodes 134 may include one or more processors 118 connected to one or more memories 110 via a memory bus. For example, each of processors 118 may correspond to a central processing unit (CPU) or a multiprocessor having multiple processor cores that may be assigned to run one or more of workloads 132. Compute nodes 134 may be distributed between different servers 130 within compute infrastructure 160, such as two compute nodes 134 for each server 130.

In some examples, each of compute nodes 134 corresponds to a non-uniform memory access (NUMA) node within a NUMA architecture, where the memory access time depends on the memory location relative to a processor. For example, processor 118-1 may access memory 110-1 (which is within the same compute node) in accordance with a first memory access time, memory 110-2 (which is part of a different compute node within the same server) in accordance with a second memory access time that is greater than the first memory access time, and memory 110-3 (which is part of a different compute node and a different server) in accordance with a third memory access time that is greater than the first and second memory access times. Compute infrastructure 160 can optimize the performance of workloads 132 that are sensitive to memory latency by strategically placing these workloads on specific compute nodes 134 (or NUMA nodes) to maximize the use of local memory accesses.

Compute infrastructure 160 may include a workload scheduler 142 that assigns incoming workloads 132 to servers 130 within compute infrastructure 160. Workload scheduler 142 may ensure that each of workloads 132 is placed on a server that can provide the necessary resources while also adhering to a set of constraints and requirements, some of which may be defined by a workload specification for each of workloads 132. When a new workload needs to be scheduled, workload scheduler 142 determines the current state of the servers by receiving a server status from each of a set of server agents 146 running on servers 130. By analyzing the server statuses, workload scheduler 142 can identify which servers have sufficient resources (CPU, memory, disk, etc.) to accommodate the workload. This assessment may include checking resource requests and limits specified in the workload specification against the available resources on each server.

Workload scheduler 142 may also consider various constraints and affinity/anti-affinity specifications. These rules can be set to ensure that workloads 132 are placed on servers 130 and compute nodes 134 that meet specific requirements or preferences. For example, some of workloads 132 may need to be co-located on the same server or compute node for performance reasons, while others might need to be spread across different servers or compute nodes for high availability and redundancy. Workload scheduler 142 may aim to balance the load across compute infrastructure 160 effectively to maintain overall performance and stability. Once workload scheduler 142 has evaluated all factors, it selects the most appropriate server and node for the workload and assigns the workload to that server and node. Workload scheduler 142 may operate continuously as new workloads are created and old workloads are destroyed.

Compute infrastructure 160 may include a set of server agents 146 running on respective servers 130. Each server agent acts as a bridge between workload scheduler 142 and compute nodes 134, managing the state and operation of compute nodes 134 running on that server. Server agents 146 ensure that workloads 132 get assigned to compute nodes 134 and that they have started and are running and healthy. Server agents 146 continuously monitor the resource usage of workloads 132 running on compute nodes 134 within the server, including processor usage, memory usage, NIC bandwidth usage, and memory bandwidth usage. This information is reported back to workload scheduler 142 as a server status. This data helps in scheduling decisions and in maintaining the desired state of compute infrastructure 160.

Workload scheduler 142 and server agents 146 work together to place workloads 132 in compute nodes 134 in deterministic groups and based on the availability of CPU resources, memory resources, memory bandwidth, and NIC bandwidth across servers and compute nodes. In some examples, each of server agents 146 may have two settings that dictate how workloads 132 are scheduled, scope and policy. The scope setting determines the level of granularity (e.g., single or multiple workloads) that is used to align resources. The policy setting defines the strategy used to align resources. In some examples, for the purposes of network function resource scheduling, the scope may be set to single workloads. This mean all sub-workloads of a workload are grouped to a single compute node or a shared set of compute nodes, and the total requested amount of a particular resource is the sum of all sub-workload resource requests. In some examples, the policy is set to a single compute node. Using the workload scope in conjunction with the single compute node policy is specifically valuable for network function workloads that are latency sensitive and have high throughput, as these workloads generally perform inter-process communication (IPC). This may also be useful for minimizing network load and increasing robustness because there are fewer hardware dependencies in the IPC path. When both options are combined, all sub-workloads in a workload are attempted to be scheduled on a single compute node, eliminating inter-node communication.

FIG. 2 illustrates example communications between server agents 246 and a workload scheduler 242 within a compute infrastructure 260, in accordance with some embodiments of the present disclosure. Each of server agents 246 may include a number of processes or plugins that gather usage and availability data within servers and compute nodes. In the illustrated example, the processes/plugins associated with each server agent includes a processor manager 261 that determines server-specific and/or compute node-specific processor usage and availability, a memory manager 263 that determines server-specific and/or compute node-specific memory usage and availability, a NIC bandwidth manager 265 that determines server-specific and/or compute node-specific NIC bandwidth usage and availability, a memory bandwidth manager 267 that determines server-specific and/or compute node-specific memory bandwidth usage and availability, and a workload manager 269 that determines server-specific and/or compute node-specific workload usage and availability.

Each of server agents 246 may repeatedly (e.g., in response to a request from workload scheduler 242 and/or at predetermined intervals) send a server status 248 to workload scheduler 242 to report the usage and availability data gathered by the above-mentioned processes. In some examples, on initialization, one or more of the plugins may communicate with server agent 246-1 via gRPC and a device plugin application programming interface (API). For example, workload manager 269 may discover the number of total compute nodes by querying the server. Workload manager 269 may then multiply the number of total compute nodes by a configurable (via environment variable) number of workload slots supported by each compute node. In some examples, this value is set to 50. The rationale being that the default limit of workloads per server is 110, the number of system workloads running on the server is 10, and the number of compute nodes in the server is 2 (i.e., (110-10)/2=50). Accordingly, the number of non-system workloads available to run on the server is 100.

The plugins may iterate through all running workloads to track resource usage and availability based on, for example, the workload resource request as indicated in a workload specification 233 for each of the running workloads. Workload specification 233 may include a workload type indicating the application(s) or network function(s) associated with the workload, a processor request indicating a number of processors or cores requested for the workload (which may be expressed as a limit), a memory request indicating an amount of memory requested for the workload (which may be expressed as a limit), a NIC bandwidth request indicating an amount of NIC bandwidth requested for the workload (which may be expressed as a limit), and a bandwidth memory request indicating an amount of memory bandwidth requested for the workload (which may be expressed as a limit). After iterating through all workloads, the plugins of server agent 246-1 may generate the resource availability numbers by subtracting the resource usage numbers from the total resource numbers.

In one example, NIC bandwidth manager 265 may generate a NIC bandwidth availability for each of the two compute nodes in the server. NIC bandwidth manager 265 may query workload manager 269 for a list of the workloads running on each of the compute nodes, and then query each of the workloads for their NIC bandwidth usage (e.g., by analyzing each workload’s specification or by determining its actual NIC bandwidth usage while running). After determining the NIC bandwidth usage for each of the compute nodes (e.g., a first NIC bandwidth usage and a second NIC bandwidth usage), NIC bandwidth manager 265 may subtract the NIC bandwidth usage from the total NIC bandwidth for each of the compute nodes (e.g., a first total NIC bandwidth and a second total NIC bandwidth) to compute the NIC bandwidth availability for each of the compute nodes (e.g., a first NIC bandwidth availability and a second NIC bandwidth availability). These NIC bandwidth availabilities may be included in server status 248-1 that is communicated to workload scheduler 242.

Additionally or alternatively, memory bandwidth manager 267 may generate a memory bandwidth availability for each of the two compute nodes in the server. Memory bandwidth manager 267 may query workload manager 269 for a list of the workloads running on each of the compute nodes, and then query each of the workloads for their memory bandwidth usage (e.g., by analyzing each workload’s specification or by determining its actual memory bandwidth usage while running). After determining the memory bandwidth usage for each of the compute nodes (e.g., a first memory bandwidth usage and a second memory bandwidth usage), memory bandwidth manager 267 may subtract the memory bandwidth usage from the total memory bandwidth for each of the compute nodes (e.g., a first total memory bandwidth and a second total memory bandwidth) to compute the memory bandwidth availability for each of the compute nodes (e.g., a first memory bandwidth availability and a second memory bandwidth availability). These memory bandwidth availabilities may be included in server status 248-1 along with the NIC bandwidth availabilities.

In some examples, the plugins may track resource usage and availability using bitmaps or arrays that indicate whether or not resources are in use. In one example, NIC bandwidth manager 265 may generate a bitmap with 100 bits representing 100 Gb/s of available NIC bandwidth between the processor and the NIC for a particular compute node. NIC bandwidth manager 265 may initialize the bitmap to all 1’s (to indicate availability) and subsequently set individual bits to 0 as it is determined that workloads running on the compute node are using portions of the bandwidth. For example, if a first workload running on the compute node is using 8 Gb/s of NIC bandwidth, NIC bandwidth manager 265 may set 8 of the 100 bits from 1 to 0, and if a second workload running on the compute node is using 6 Gb/s of NIC bandwidth, NIC bandwidth manager 265 may set an additional 6 of the 100 bits from 1 to 0, resulting in 14 bits set to 0 and 86 bits set to 1 indicating a NIC bandwidth usage of 14 Gb/s and a NIC bandwidth availability of 86 Gb/s for the compute node. NIC bandwidth manager 265 may repeat these steps for the second compute node in the server.

In some examples, workload scheduler 242 receives a workload 232 to be scheduled. In response, workload scheduler 242 may request server statuses 248 from server agents 246. Upon receiving server statuses 248, workload scheduler 242 reviews server statuses 248 along with workload specification 233 to determine which server should handle workload 232. In some examples, workload specification 233 may include a grouping identifier (or grouping ID) that indicates a particular group for which workloads in that group are to be assigned to the same compute node. Furthermore, workloads with different grouping IDs are to be assigned to different servers and/or different compute nodes. In the illustrated example, workload specification 233 indicates that workload 232 is to be grouped in Group A. Workload scheduler 242 may review server statuses 248 to determine whether any workloads in Group A are already running on any of the servers or compute nodes. If a workload in Group A is already running on a particular compute node, workload scheduler 242 may assign workload 232 to the corresponding server that includes the particular compute node. If no workloads in Group A are currently running on any compute nodes, workload scheduler 242 may assign workload 232 while ignoring any grouping limitation.

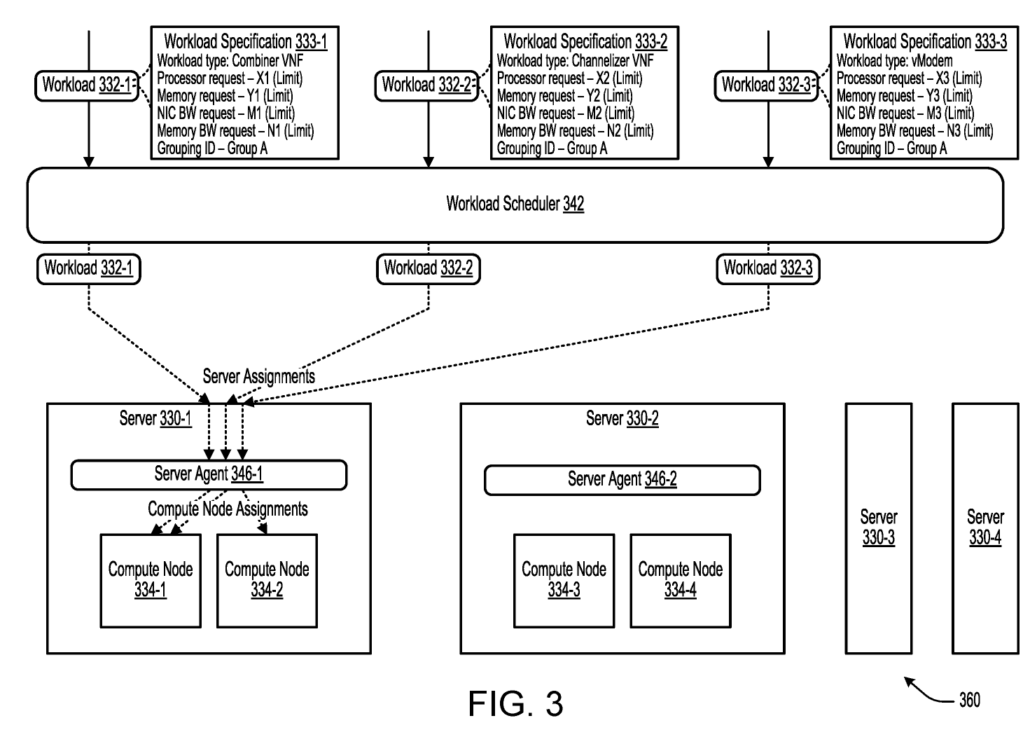

FIG. 3 illustrates example server and compute node assignments for a set of workloads 332 that are to run on a compute infrastructure 360, in accordance with some embodiments of the present disclosure. Compute infrastructure 360 may correspond to a cluster of a cloud computing architecture having a set of servers 330, each including one or more compute nodes 334. In the illustrated example, a workload scheduler 342 receives three workloads 332 to be assigned, including workload 332-1 for a combiner VNF, workload 332-2 for a channelizer VNF, and workload 332-3 for a vModem. Workload scheduler 342 may review workload specifications 333 associated with workloads 332 to determine, based on grouping IDs, that workloads 332 are to be placed on the same compute node on the same physical server.

In addition to the grouping limitation, workload scheduler 342 reviews the resource requests as indicated in workload specifications 333 along with the resource availabilities as indicated in server statuses received from server agents 346 to generate the server assignments. In the illustrated example, workload scheduler 342 assigns each of workloads 332 to server 330-1 and passes the workloads to server agent 346-1 for compute node assignments. Server agent 346-1 also reviews the resource requests as indicated in workload specifications 333 along with the grouping limitation and attempts to assign the workloads the same compute node. Based on resource availabilities, server agent 346-1 may determine that only workloads 332-1 and 332-2 can be assigned to run on compute node 334-1 and that workload 332-3 can be assigned to run on compute node 334-2. In some examples, if a workload cannot be placed with others in the group due to lack of resources, the workload may not be assigned to another compute node on the same server. Instead, the workload specification is updated and the workload request is re-submitted.

In some examples, if a particular grouping ID is found on running workloads, one of more of the plugins running on server agent 346-1 may generate a compute node mask that matches the compute node (e.g., compute node 334-1) on which the existing workloads are running. The compute node mask may be a configuration setting that specifies how the workload’s resources are aligned with a particular compute node’s topology. Alternatively, if there are no workloads running with the particular grouping ID, then the plugin(s) of server agent 346-1 can create a compute node mask that matches any compute node (e.g., either of compute nodes 334-1 or 334-2). If there are workloads running with a different grouping ID, server agent 346-1 may check to see if there any available compute nodes that can hold the particular grouping ID. If a non-matching group is already running on each compute node, then server agent 346-1 can creates a ‘0’ compute node mask, which indicates that 0 compute nodes are available. Otherwise, server agent 346-1 may create a compute node mask indicating the compute nodes that are available to run the workload. Server agent 346-1 reviews the compute node mask as well as the resource usages and availabilities. If all resources can be allocated on a single compute node, the workload is started on that compute node. If any one of the resources requests cannot be met, the workload may be rejected.

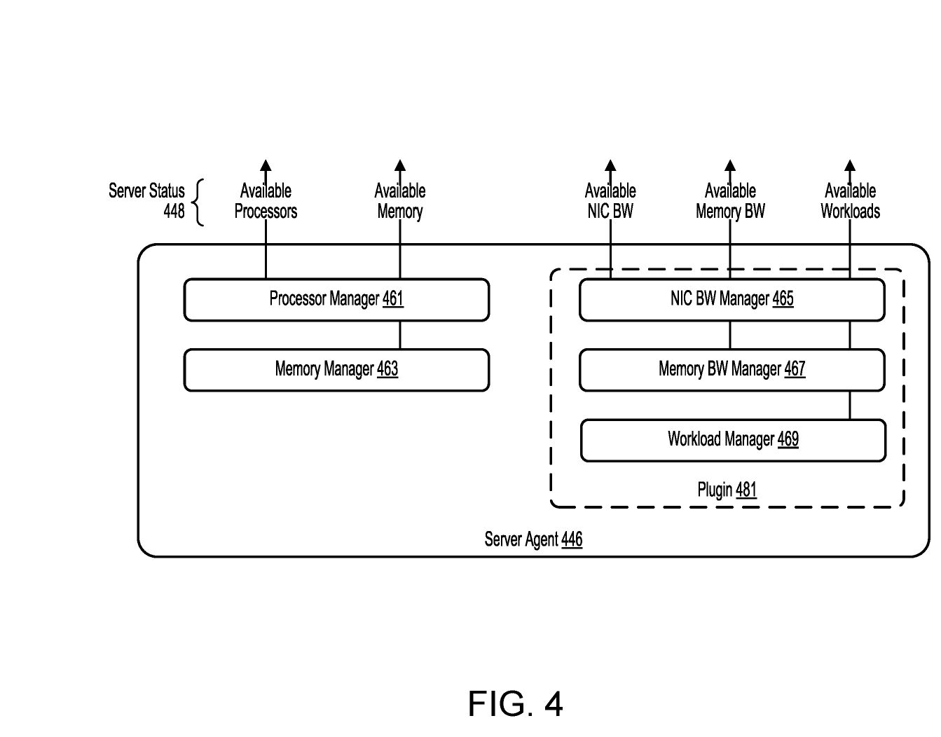

FIG. 4 illustrates an example server agent 446, in accordance with some embodiments of the present disclosure. Server agent 446 may include a number of processes or plugins that gather usage and availability data within servers and compute nodes, including a processor manager 461, a memory manager 463, a NIC bandwidth manager 465, a memory bandwidth manager 467, and a workload manager 469. As described herein, the usage and availability data gathered by these processes may be sent as a server status 448 to a workload scheduler. In some examples, NIC bandwidth manager 465, memory bandwidth manager 467, and workload manager 469 may be implemented together as a plugin 481 running on the server. In some examples, plugin 481 may be initialized on each server in the compute infrastructure to perform many of the embodiments of the present disclosure.

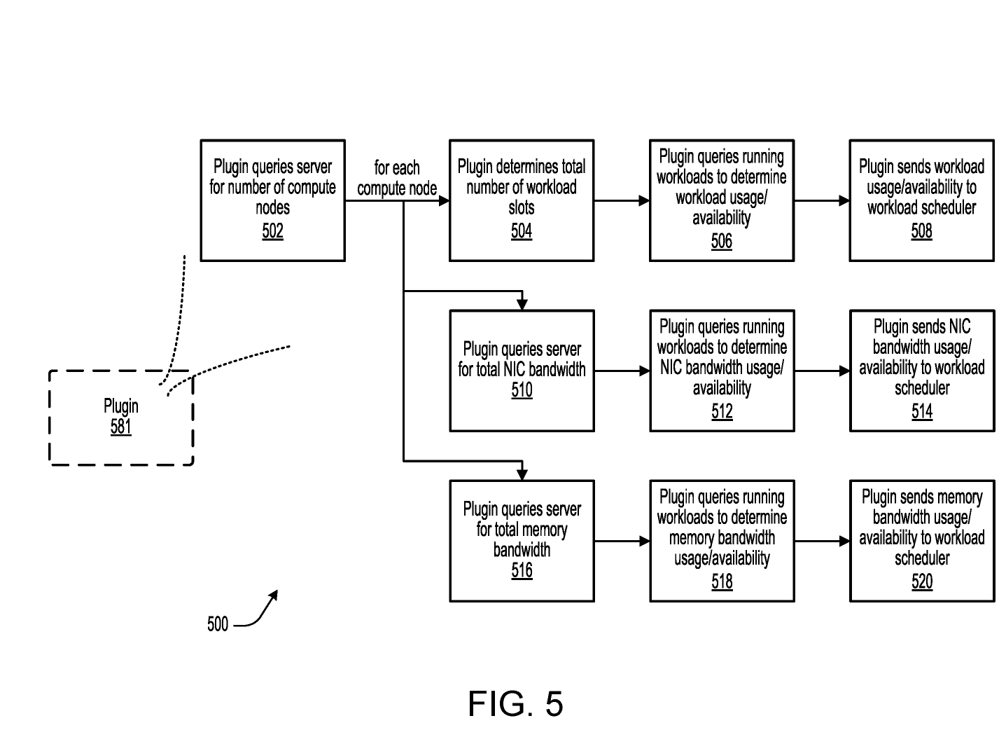

FIG. 5 illustrates an example method 500 performed by a plugin 581 running on a server of a compute infrastructure, in accordance with some embodiments of the present disclosure. Steps of method 500 may be performed in any order and/or in parallel, and one or more steps of method 500 may be optionally performed. One or more steps of method 500 may be performed by one or more processors. Method 500 may be implemented as a computer-readable medium or computer program product comprising instructions which, when the program is executed by one or more processors, cause the one or more processors to carry out the steps of method 500.

At step 502, the plugin queries the server for the number of compute nodes in the server (e.g., 2). The plugin may then perform the remaining steps of method 500 for each of the compute nodes in the server.

At step 504, the plugin determines the number of total workloads slots on the compute node (e.g., 50).

At step 506, the plugin queries the running workloads to determine workload usage and availability for the compute node. Step 506 may include determining the number of used workload slots and/or the number of available workload slots for the compute node.

At step 508, the plugin sends the workload usage and availability information for the compute node to the workload scheduler.

At step 510, the plugin queries the server for the total NIC bandwidth (e.g., 100 Gb/s) for the compute node.

At step 512, the plugin queries the running workloads to determine NIC bandwidth usage and availability for the compute node.

At step 514, the plugin sends the NIC bandwidth usage and availability information for the compute node to the workload scheduler.

At step 516, the plugin queries the server for the total memory bandwidth (100 Gb/s) for the compute node.

At step 518, the plugin queries the running workloads to determine memory bandwidth usage and availability for the compute node.

At step 520, the plugin sends the memory bandwidth usage and availability information for the compute node to the workload scheduler.

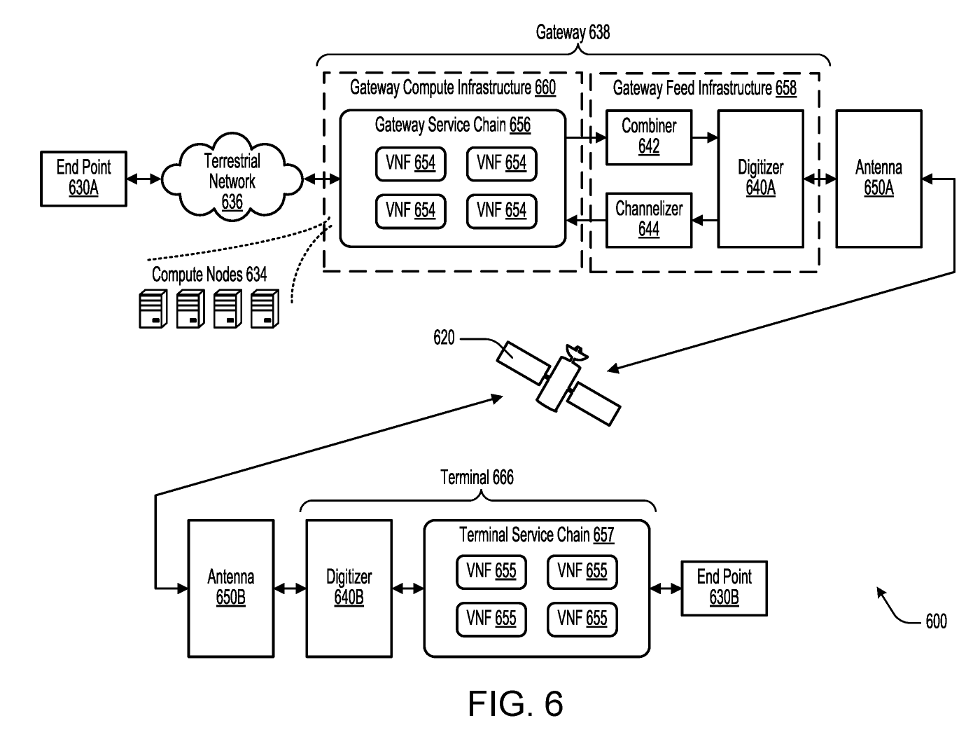

FIG. 6 illustrates an example communication path between an end point 630A and an end point 630B enabled by a satellite communication system 600, in accordance with some embodiments of the present disclosure. In the illustrated example, satellite communication system 600 includes a gateway 638 in communication with a terminal 666 via a satellite 620. In various examples, satellite 620 may send and receive wireless signals within one or more bands of a number of possible frequency bands between 1-300 GHz including, for example, 1 GHz and 300 GHz, including L Band (1-2 GHz), C-Band (4-8 GHz), X-Band (8-12 GHz), Ku-Band (12-18 GHz), Ka-Band (26.5-40 GHz), S-Band (2-4 GHz), and V-Band (40-75 GHz).

In various examples, end points 630 may correspond to portable mobile devices, internet of things (IoT) devices, desktop computers, user terminals, or any of a number of devices with communication capabilities. Alternatively, end points 630 may correspond to networks such as mobile towers, mining sites, ships, planes, or the like. In one example, end point 630A may correspond to a service and end point 630B may correspond to a consumer. It should be understood that the satellite communication environment may comprise other end points 610 and/or other arrangements of components than those illustrated. Furthermore, multiple communication paths may be constructed and operated in parallel, and separate communication paths may have different arrangements from each other.

End point 630A may be communicatively connected via a terrestrial network 636 (e.g., comprising the Internet, a private telecom backbone, or a cloud compute center) to a gateway 638. Gateway 638 may include one or more switches (not shown) to facilitate communication between the various components, such as a first switch at the boundary between terrestrial network 636 and a gateway compute infrastructure 660, and a second switch at the boundary between gateway compute infrastructure 660 and a gateway feed infrastructure 658. Such switches may be physical or virtual Gigabit Ethernet (GigE) switches. However, it should be understood that the above-described first and second switches could be implemented in the same switch. In some examples, the first switch may implement transport from terrestrial network 636 to a VNF 654 within a gateway service chain 656. In such a case, VNF 654 may act as a User Network Interface (UNI) or an External Network-Network Interface (ENNI) as defined by the applicable MEF Ethernet services and MEF operator services standards. Alternatively, the first switch may itself represent the UNI as defined by the applicable MEF standards.

Gateway compute infrastructure 660 may include a set of compute nodes 634 situated onsite (at a same physical location) or offsite (at a different physical location) relative to antenna 650. In some examples, compute nodes 634 may comprise general-purpose computers or servers capable of running VNFs 654 (e.g., as workloads) and other virtualization software such as hypervisors to support gateway service chain 656. In some examples, compute nodes 634 may employ x86 architectures, ARM architectures, RISC-V architectures, among other possibilities. Compute nodes 634 may be configured as clusters, data centers, warehouse-scale computers, among other possibilities. Gateway compute infrastructure 660 may further include suitable storage systems that provide persistent and reliable storage in support of VNFs 654.

In some examples, gateway compute infrastructure 660 may include a managing system that instantiates and configures one or more VNFs 654 to form gateway service chain 656. Two sets of one or more VNFs 654 may provide two-way communication, including a transmission path and a reception path, between terrestrial network 636 and a gateway feed infrastructure 658 of gateway 656. It should be understood that in an example in which gateway service chain 656 provides only one-way communication, VNFs 654 may provide only a transmission path without providing a reception path. The set of VNFs 654 (e.g., implementing a gateway) on the forward path towards the link to satellite 620, may comprise or constitute a traffic handler, an encapsulator (e.g., implementing generic stream encapsulation (GSE)), a modulator (e.g., the OpenSpace™ Wideband Software modulator, offered by Kratos Defense & Security Solutions, Inc. of San Diego, California), a combiner, an encryption/decryption VNF, a time division multiple access (TDMA) resource allocator, an antenna controller, among other possibilities.

This set of VNFs 654 on the transmission path may convert protocol data units (PDUs) into a digital signal (such as a digital intermediate frequency (IF) waveform or a composite digital IF waveform). For example, the traffic handler may process data link layer (e.g., Layer 2 or L2 in the Open Systems Interconnection (OSI) model) and/or network layer (e.g., Layer 3 or L3 in the OSI model) traffic, and provide the processed Ethernet frames or IP packets to the encapsulator. The encapsulator may convert the PDUs into baseband frames, and provide the baseband frames to the modulator. A baseband frame may be the basic unit of transmission in satellite communication system 600. The encapsulator may form baseband frames in accordance with the 5G standard, the DVB-S2x standard, described in European Telecommunications Standards Institute (ETSI) European Standard (EN) 302 307-1 v1.4.1 (2014-11), among other possible standards. The encapsulator may comprise one or more VNFs 654 (or software subprocesses) that perform one or more of the following functions: frame chopping, forward modulation selection (e.g., with Adaptive Coding and Modulation (ACM)), Ethernet bridge (e.g., Media Access Control (MAC) table, smart bridging/learning/relay, etc.), Address Resolution Protocol (ARP) (e.g., Ethernet MAC discovery), VLAN manipulation (e.g., to rewrite Ethernet frames on ingress/egress based on the MEF service definition), header compression (e.g., Robust Header Compression (ROHC)); and/or OTA optimization (e.g., Space Communications Protocol Specifications (SCPS)/TCP-Acceleration). The modulator may convert the baseband frames into signal data packets in accordance with a particular standard, including the standards of the Digital Intermediate Frequency Interoperability (DIFI) Consortium in the DIFI/Institute of Electrical and Electronics Engineers (IEEE) 1.0 specification, the VMEbus International Trade Association (VITA) standard, the enhanced Common Public Radio Interface (eCPRI) standard, among other possibilities. In an embodiment, the encapsulator and the traffic handler may be implemented as a single VNF 654, referred to as a virtualized traffic adaptor (vModem). The VNF-implemented combiner or a combiner 642 (implemented in hardware) may combine the signal data packets into a digital signal and provide the digital signal to a digitizer 640A, which may convert the digital signal into an analog signal.

The set of VNFs 654 on the return path may comprise or constitute, in order, a digital channelizer (e.g., the OpenSpace™ Wideband Channelizer, offered by Kratos Defense & Security Solutions, Inc. of San Diego, California), a demodulator (e.g., the OpenSpace™ Wideband Software Receiver, offered by Kratos Defense & Security Solutions, Inc. of San Diego, California), and a decapsulator. This set of VNFs 654 on the reception path may convert a digital signal (such as a digital IF waveform or a composite digital IF waveform) to PDUs, which may be Ethernet frames or IP packets, among other possibilities. For example, the VNF-implemented channelizer or a channelizer 644 (implemented in hardware) may receive a digital signal from digitizer 640A, which has converted an analog signal into the digital signal, and divide the digital signal into signal data packets. The demodulator may convert the signal data packets to baseband frames, and provide the baseband frames to the decapsulator. The decapsulator may convert the baseband frames into PDUs, which may be transmitted, via terrestrial network 636, to end point 630A. It should be understood that the demodulator performs the reverse function(s) of the modulator, and the decapsulator performs the reverse function(s) of the encapsulator. In an embodiment, the decapsulator and demodulator may be implemented as a single VNF 654, for example, together with the traffic handler, encapsulator, and modulator, in a vModem. In other words, a vModem may consist of a single VNF 654 that implements all of the functions of the traffic handler, encapsulator/decapsulator, and modulator/demodulator.

In some embodiments, in which gateway service chain 656 implements a vModem, the vModem may comprise one or more modulators that are configured to modulate waveforms according to a digital satellite broadcast standard and/or one or more demodulators that are configured to demodulate waveforms according to a digital satellite broadcast standard. Such a vModem may provide carrier ethernet (CE) services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames. The digital satellite broadcast standard may be a digital satellite television broadcast standard, such as the DVB-S2X standard managed by the Digital Video Broadcasting (DVB) Project. While a digital satellite broadcast standard, such as a DVB standard, is used as an example, the vModem may be configured to modulate and demodulate waveforms according to other standards for wideband digital communication, such as orthogonal frequency-division multiplexing (OFDM), or the like.

The digital signal from combiner 642 is transmitted to digitizer 640A, which converts the digital signal output by combiner 642 into an analog transmission signal for communication to satellite 620. Digitizer 640A further digitizes analog reception signals from satellite 620 into digital signals for use by channelizer 644. In some examples, digitizer 640A may be software-defined. As one example, digitizer 640A may be a SpectralNet™, which is a carrier-grade RF digitizer, offered by Kratos Defense & Security Solutions, Inc. of San Diego, California. Digitizer 640A communicates with antenna 650A. In particular, digitizer 640A provides the transmission signal to antenna 650A, which transmits the transmission signal to satellite 620. In addition, in two-way communications, antenna 650A receives a reception signal from satellite 620, and provides the reception signal to digitizer 640A.

In various examples, antenna 650A may be a parabolic reflector antenna, a flat panel antenna, a phased array antenna, a helical antenna, a patch antenna, a horn antenna, among other possibilities. In some examples, antenna 650A may be an electronically steered antenna that can use electronic means to control the direction and shape of its radiation pattern. Such an antenna can generate multiple beams simultaneously, allowing it to transmit or receive signals in multiple directions at the same time. Antenna 650A may include both the physical antenna as well as the corresponding radio frequency (RF) subsystem, which may include a combination of diplexers, amplifiers (e.g., low noise amplifiers (LNAs)), upconverters, and downconverters (e.g., low-noise block downconverters (LNBs) depending on the specific frequency band and application.

Satellite 620 relays wireless signals from antenna 650A to antenna 650B. In two-way communications, satellite 620 also relays wireless signals from antenna 650B to antenna 650A. Antenna 650B may be functionally similar or identical to antenna 650A, and therefore, any description of antenna 650A applies equally to antenna 650B, which may not be redundantly described herein. Similarly, digitizer 640B may be functionally similar or identical to digitizer 640A, and therefore, any description of digitizer 640A applies equally to digitizer 640B, which may not be redundantly described herein.

Digitizer 640B may communicate directly with a terminal service chain 657 of a terminal compute infrastructure. Terminal service chain 657 may comprise a set of VNF(s) 655 forming a reception path from digitizer 640B to end point 630B. In two-way communications, terminal service chain 657 may also comprise a set of VNFs 655 forming a transmission path from end point 630B to digitizer 640B. The reception and transmission paths may be identical or similar to the reception and transmission paths described with respect to gateway service chain 656. For example, the reception path may comprise a demodulator followed by a decapsulator to convert signal frames into PDUs, and the transmission path may comprise an encapsulator followed by a modulator to convert PDUs into signal frames. The traffic handler, encapslator, decapsulator, modulator, and demodulator may all be similar or identical to those described with respect to gateway service chain 656, and therefore, the descriptions of those components with respect to gateway service chain 656 apply equally to those components in terminal service chain 657.

Terminal service chain 657 may communicate with end point 630B. For example, the traffic handler of terminal service chain 657 may transmit Ethernet frames to end point 630B. In addition, in two-way communications, the encapsulator of terminal service chain 657 may receive PDUs from end point 630B. Thus, the combination of gateway service chain 656 and terminal service chain 657 enable one-way or two-way communications between end points 610A and 610B over a satellite link.

Gateway service chain 656 and terminal service chain 657 may comprise one or more of the software-defined components (e.g., VNFs and/or digitizers) described in International Patent App. Nos. PCT/US2021/033867, filed on May 24, 2021, PCT/US2021/033875, filed on May 24, 2021, PCT/US2021/033905, filed on May 24, 2021, and PCT/US2021/062689, filed on Dec. 9, 2021, which are all hereby incorporated herein by reference as if set forth in full.

Advantageously, the utilization of VNFs and software-defined components (e.g., digitizers 640A and 640B) to perform various functions, aid in automation and scalability. Embodiments may minimize the presence of physical hardware components, such that satellite communication system 600 can be dynamically reconfigured (e.g., added, updated, destroyed, increased or decreased in dimension, etc.) in real time, primarily using in-band network communications, to adapt to the unique multivariate satcom environment (e.g., changing traffic patterns, RF interference, atmospheric characteristics, antenna conditions, path length, etc.) and to schedule low Earth orbit (LEO) telemetry, tracking, and command (TT&C) passes.

Notably, dynamic reconfiguration of VNFs in a cloud computing environment can be used, not only to increase the dimensions of the computing resources (e.g., number of vCPUs, amount of memory and/or disk storage, network throughput, etc.) used for satellite communication system 600 on demand to ensure the sufficiency of the satellite communication system, but also to decrease the dimensions of the computing resources on demand to optimize the utilization of the hardware. For example, favorable changes in the satcom environment may improve performance of satellite communication system 600, such that satellite communication system 600 is providing significantly better performance than is required by the service level agreement. In this case, the management system may determine that gateway service chain 656 and terminal service chain 657 are excessive, and update the service chains to reduce the resources used in the service chains (e.g., by reducing RF bandwidth usage, resizing one or more VNFs, swapping to a service chain with reduced dimensions, etc.). This is in contrast to conventional hardware-based service chains in which unused resources would simply be idled or otherwise ignored, representing a sunk cost that cannot be recouped.

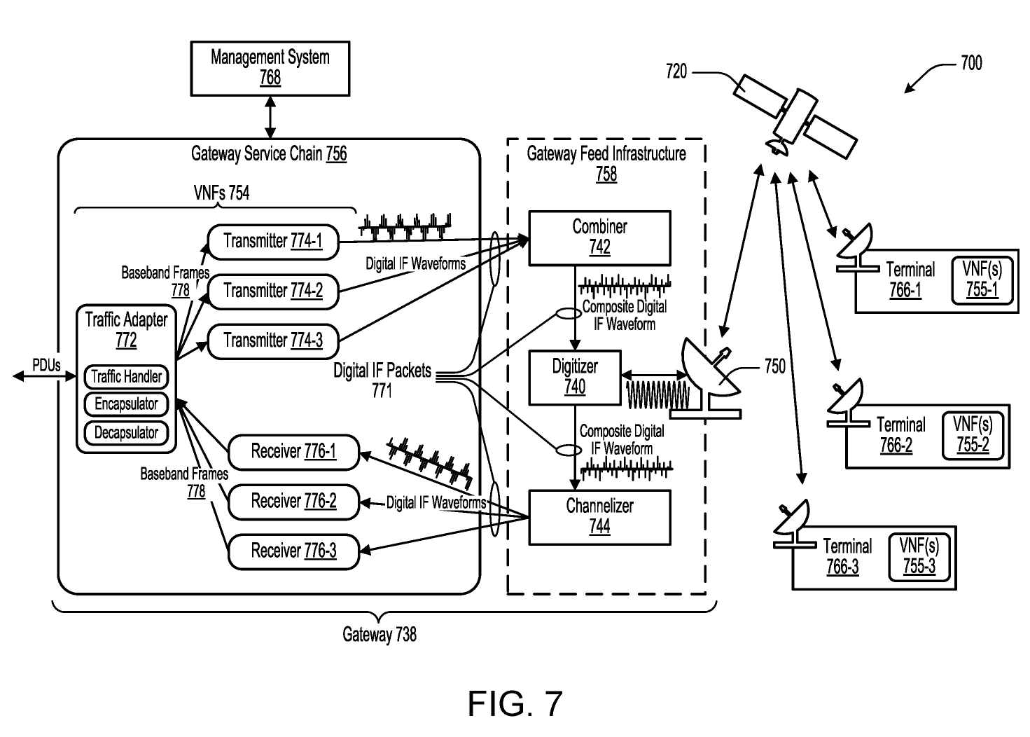

FIG. 7 illustrates an example satellite communication system 700 including a gateway 738 and a set of terminals 766 (or “remote terminals”), in accordance with some embodiments of the present disclosure. In the illustrated example, satellite communication system 700 includes a gateway 738 (or “hub”) in communication with each of terminals 766 via a satellite 720. Gateway 738 may include a gateway feed infrastructure 758 that serves as an onsite infrastructure (close to antenna 750, e.g., at a same physical location) that may perform primarily signal digitization and signal routing-related tasks and a gateway compute infrastructure that can be onsite or offsite infrastructure (far from antenna 750, e.g., at a different physical location) that supports a gateway service chain 756 that performs primarily signal processing and packet processing-related tasks. The gateway compute infrastructure may include one or more computers, clusters, a data center, or a warehouse-scale computer. The compute nodes comprising the gateway compute infrastructure and/or gateway feed infrastructure 758 may include general-purpose computers or servers employing x86 architectures, ARM architectures, RISC-V architectures, among other possibilities.

Gateway 738 may include a gateway service chain 756 comprising a set of VNFs 754 running on the gateway compute infrastructure. Example VNFs include one or more traffic adapters 772, one or more virtual transmitters 774, one or more virtual receivers 776, among other possibilities. Each of VNFs 754 may be instantiated and configured by a management system 768 that scales up or down the number of active VNFs based on the number of active terminals 766. Management system 768 may further configure VNFs 754 such that satellite communication system 700 implements any one of a number of network topologies, including a single channel per carrier (SCPC) network, a TDMA network, a frequency division multiple access (FDMA) network, a mesh network, among other possibilities.

VNFs 754 may include one or more virtual transmitters 774 that provide one or more transmission paths between a terrestrial network and a gateway feed infrastructure 758 of gateway 756. Each of the set of virtual transmitters 774 on a transmission path may comprise or constitute a modulator (e.g., the OpenSpace™ Wideband Software modulator) that converts incoming baseband frames 778 into digital IF packets 771 containing digital waveforms at IF or RF frequencies (or “digital IF waveforms”). Traffic adapter 772 acts as the bridge between the terrestrial network and the satellite network. In some examples, traffic adapter 772 may include a traffic handler that processes data link layer (e.g., Layer 2 in the OSI model) and/or network layer (e.g., Layer 3 in the OSI model) traffic and provides the processed PDUs to the encapsulator, which convert the PDUs into baseband frames 778 and provides baseband frames 778 to one of virtual transmitters 774. Each of virtual transmitters 774 may implement a modulator that converts baseband frames 778 into digital IF packets 771 (e.g., according to the standards of the DIFI Consortium in the DIFI/IEEE 1.2 specification) to create the digital IF waveforms.

Digital IF packets 771 generated by virtual transmitters 774 may be fed into a combiner 742 that combines the multiple digital IF waveforms into a single composite signal (or “composite digital IF waveform”). Digital IF packets 771 containing the composite digital IF waveform is fed into a digitizer 740 that converts the digital signal into an analog signal in preparation for wireless transmission via an antenna 750. While combiner 742 is illustrated in FIG. 7 as being an element of gateway feed infrastructure 758, it is to be understood that a combiner VNF (or multiple combiner VNFs) may be instantiated by management system 768 to perform similar functionality.

On the reception path, digitizer 740 digitizes analog signals received from satellite 720 to generate digital IF packets 771 containing digital IF waveforms (e.g., a composite digital IF waveform) of the received analog signals for use by a channelizer 744. The composite digital IF waveform received by channelizer 744 may be a wide-band spectrum (e.g., 100 MHz, 500 MHz, 300 GHz, etc.) that may contain several signals within that segment of the frequency band. In some instances, channelizer 744 divides the composite digital IF waveform into separate digital IF waveforms and sends the waveforms (in the form of digital IF packets 771) to appropriate virtual receivers 776. While channelizer 744 is illustrated in FIG. 7 as being an element of gateway feed infrastructure 758, it is to be understood that a channelizer VNF (or multiple channelizer VNFs) may be instantiated by management system 768 to perform similar functionality. VNFs 754 may include one or more virtual receivers 776 that provide one or more reception paths between gateway feed infrastructure 758 and a terrestrial network. Each of the set of virtual receivers 776 on a reception path may comprise or constitute a demodulator (e.g., the OpenSpace™ Wideband Software Receiver) that converts incoming digital IF packets 771 containing digital IF waveforms into baseband frames 778. In some examples, baseband frames 778 produced by virtual receivers are sent to the decapsulator of traffic adapter 772. The decapsulator may convert baseband frames 778 into Ethernet frames and pass the Ethernet frames to the traffic handler, which processes and provides the Ethernet frames to a terrestrial network.

Satellite 720 relays wireless signals from antenna 750 to the antennas of terminals 766, or vice versa. In two-way communications, satellite 720 also relays wireless signals from the antennas of terminals 766 to antenna 750. In some examples, each of terminals 766 may include hardware infrastructure to support one or more VNFs 755. In some examples, VNFs 755 at each of terminals 766 may implement a vModem that comprises one or more modulators that are configured to modulate waveforms according to a digital satellite broadcast standard and/or one or more demodulators that are configured to demodulate waveforms according to the digital satellite broadcast standard. Such a vModem may provide CE services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames, together with a traffic handler that connects the encapsulators and decapsulators with the terrestrial networks connected to terminals 766.

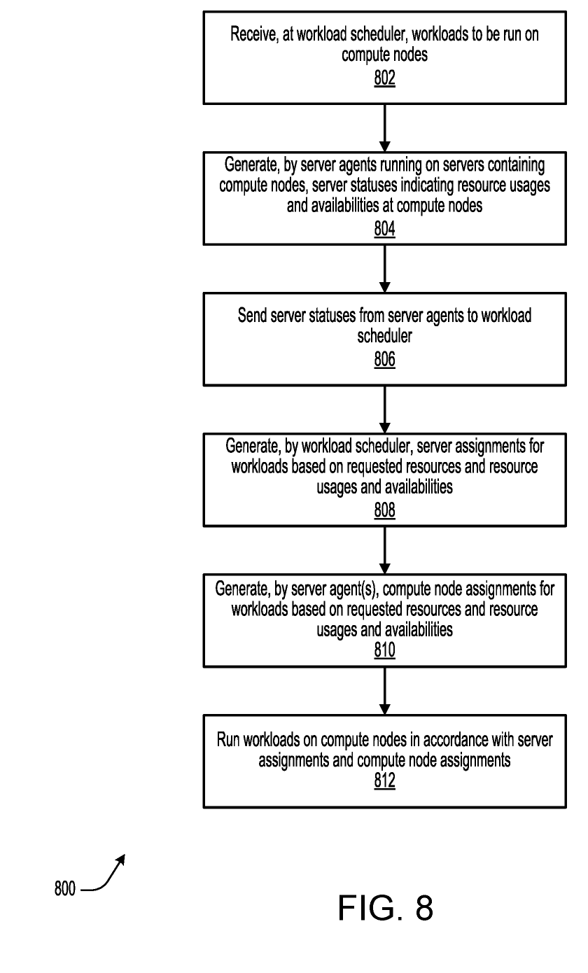

FIG. 8 illustrates an example method 800 of assigning a set of workloads (e.g., workloads 132, 232, 332) to compute nodes (e.g., compute nodes 134, 334) in a compute infrastructure (e.g., compute infrastructures 160, 260, 360, 660), in accordance with some embodiments of the present disclosure. Steps of method 800 may be performed in any order and/or in parallel, and one or more steps of method 800 may be optionally performed. One or more steps of method 800 may be performed by one or more processors. Method 800 may be implemented as a computer-readable medium or computer program product comprising instructions which, when the program is executed by one or more processors, cause the one or more processors to carry out the steps of method 800.

At step 802, the set of workloads to be run on the compute nodes are received at a workload scheduler (e.g., workload schedulers 142, 242, 342). The set of workloads may be VNF workloads, each corresponding to one or more VNFs (e.g., VNFs 654, 655, 754, 755). Each workload of the set of workloads may have a workload specification (e.g., workload specifications 233, 333) indicating requested resources to run the workload. The workload specification may indicate at least one of a processor request indicating a number of processors or cores requested for the workload, a memory request indicating an amount of memory requested for the workload, a NIC bandwidth request indicating an amount of NIC bandwidth requested for the workload, or a memory bandwidth memory request indicating an amount of memory bandwidth requested for the workload. The workload specification may indicate a grouping ID, where workloads having a same grouping ID are attempted to be assigned to a same compute node and workloads having different grouping IDs are to be assigned to different compute nodes.

At step 804, a set of server agents (e.g., server agents 146, 246, 346, 446) running on a set of servers (e.g., servers 130, 330) containing the compute nodes generate server statuses (e.g., server statuses 248, 448) indicating resource usages and availabilities at the compute nodes. Each of the server statuses may indicate at least one of a processor availability at a compute node of a corresponding server, a memory availability at the compute node, a NIC bandwidth availability at the compute node, or a memory bandwidth availability at the compute node.

At step 806, the server statuses are sent from the set of server agents to the workload scheduler.

At step 808, server assignments for the set of workloads are generated by the workload scheduler based on the requested resources and the resource usages and availabilities. In some examples, generating the server assignments for the set of workloads includes assigning a first workload (e.g., workload 332-1), a second workload (e.g., workload 332-2), and a third workload (e.g., e.g., workload 332-3) of the set of workloads to a first server (e.g., server 330-1) of the set of servers. In such examples, the workload specification for each of the first workload, the second workload, and the third workload may indicate a same grouping ID. In some examples, generating the server assignments for the set of workloads includes assigning the first workload to the first server, the second workload to a second server (e.g., server 330-2), and the third workload to a third server (e.g., server 330-3). In such examples, the workload specifications for the first workload, the second workload, and the third workload may indicate different grouping IDs.

At step 810, compute node assignments for the set of workloads are generated by one or more of the set of server agents based on the requested resources and the resource usages and availabilities. In some examples, generating the compute node assignments for the set of workloads includes assigning the first workload and the second workload to a first compute node (e.g., compute node 334-1) of the first server and assigning the third workload to a second compute node (e.g., compute node 334-2) of the first server.

At step 812, the set of workloads are run on the compute nodes in accordance with the server assignments and the compute node assignments.

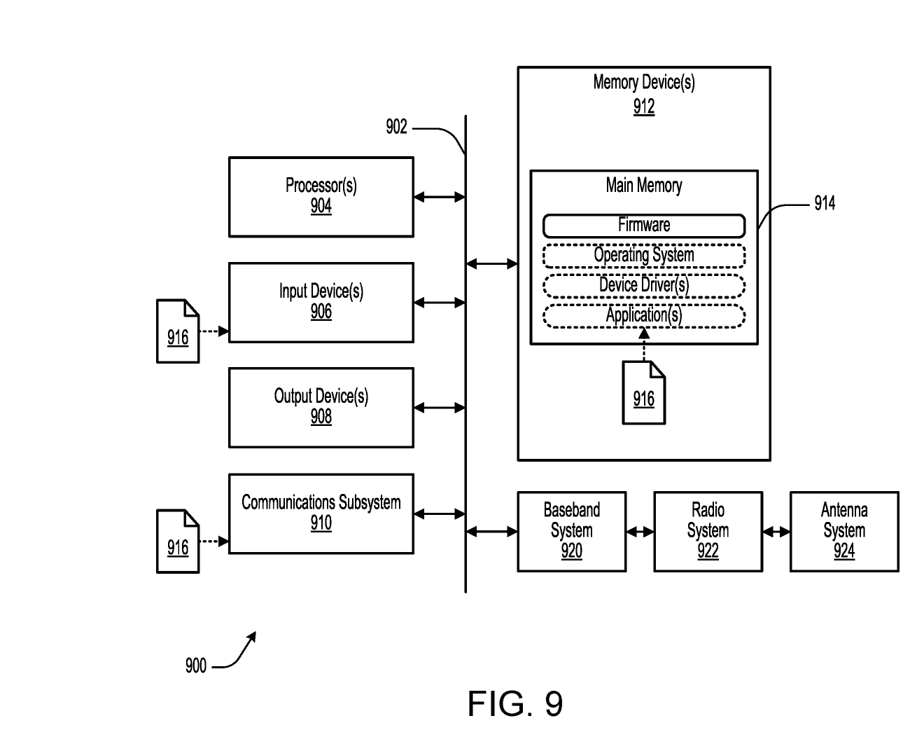

FIG. 9 illustrates an example computer system 900 comprising various hardware elements, in accordance with some embodiments of the present disclosure. Computer system 900 may be incorporated into or integrated with devices described herein and/or may be configured to perform some or all of the steps of the methods provided by various embodiments. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner.

In the illustrated example, computer system 900 includes a communication medium 902, one or more processor(s) 904, one or more input device(s) 906, one or more output device(s) 908, a communications subsystem 910, one or more memory device(s) 912, a baseband system 920, a radio system 922, and an antenna system 924. Computer system 900 may be implemented using various hardware implementations and embedded system technologies. For example, one or more elements of computer system 900 may be implemented within an integrated circuit (IC), an application-specific integrated circuit (ASIC), an application-specific standard product (ASSP), a field-programmable gate array (FPGA), such as those commercially available by XILINX®, INTEL®, or LATTICE SEMICONDUCTOR®, a system-on-a-chip (SoC), a microcontroller, a printed circuit board (PCB), and/or a hybrid device, such as an SoC FPGA, among other possibilities.

The various hardware elements of computer system 900 may be communicatively coupled via communication medium 902. While communication medium 902 is illustrated as a single connection for purposes of clarity, it should be understood that communication medium 902 may include various numbers and types of communication media for transferring data between hardware elements. For example, communication medium 902 may include one or more wires (e.g., conductive traces, paths, or leads on a PCB or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, communication medium 902 may include one or more buses that connect the pins of the hardware elements of computer system 900. For example, communication medium 902 may include a bus that connects processor(s) 904 with main memory 914, referred to as a system bus, and a bus that connects main memory 914 with input device(s) 906 or output device(s) 908, referred to as an expansion bus. The system bus may itself consist of several buses, including an address bus, a data bus, and a control bus. The address bus may carry a memory address from processor(s) 904 to the address bus circuitry associated with main memory 914 in order for the data bus to access and carry the data contained at the memory address back to processor(s) 904. The control bus may carry commands from processor(s) 904 and return status signals from main memory 914. Each bus may include multiple wires for carrying multiple bits of information and each bus may support serial or parallel transmission of data.

Processor(s) 904 may include one or more central processing units (CPUs), graphics processing units (GPUs), neural network processors or accelerators, digital signal processors (DSPs), and/or other general-purpose or special-purpose processors capable of executing instructions. A CPU may take the form of a microprocessor, which may be fabricated on a single IC chip of metal–oxide–semiconductor field-effect transistor (MOSFET) construction. Processor(s) 904 may include one or more multi-core processors, in which each core may read and execute program instructions concurrently with the other cores, increasing speed for programs that support multithreading.

Input device(s) 906 may include one or more of various user input devices such as a mouse, a keyboard, a microphone, as well as various sensor input devices, such as an image capture device, a temperature sensor (e.g., thermometer, thermocouple, thermistor), a pressure sensor (e.g., barometer, tactile sensor), a movement sensor (e.g., accelerometer, gyroscope, tilt sensor), a light sensor (e.g., photodiode, photodetector, charge-coupled device), and/or the like. Input device(s) 906 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

Output device(s) 908 may include one or more of various devices that convert information into human-readable form, such as without limitation a display device, a speaker, a printer, a haptic or tactile device, and/or the like. Output device(s) 908 may also include devices for writing to removable storage devices or other removable media, such as those described in reference to input device(s) 906. Output device(s) 908 may also include various actuators for causing physical movement of one or more components. Such actuators may be hydraulic, pneumatic, electric, and may be controlled using control signals generated by computer system 900.

Communications subsystem 910 may include hardware components for connecting computer system 900 to systems or devices that are located external to computer system 900, such as over a computer network. In various embodiments, communications subsystem 910 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 802.11 device, a Wi-Fi device, a Wi-Max device, a cellular device), among other possibilities.

Memory device(s) 912 may include the various data storage devices of computer system 900. For example, memory device(s) 912 may include various types of computer memory with various response times and capacities, from faster response times and lower capacity memory, such as processor registers and caches (e.g., L0, L1, L2), to medium response time and medium capacity memory, such as random-access memory (RAM), to lower response times and lower capacity memory, such as solid-state drives and hard drive disks. While processor(s) 904 and memory device(s) 912 are illustrated as being separate elements, it should be understood that processor(s) 904 may include varying levels of on-processor memory, such as processor registers and caches that may be utilized by a single processor or shared between multiple processors.

Memory device(s) 912 may include main memory 914, which may be directly accessible by processor(s) 904 via the address and data buses of communication medium 902. For example, processor(s) 904 may continuously read and execute instructions stored in main memory 914. As such, various software elements may be loaded into main memory 914 to be read and executed by processor(s) 904 as illustrated in FIG. 9. Typically, main memory 914 is volatile memory, which loses all data when power is turned off and accordingly needs power to preserve stored data. Main memory 914 may further include a small portion of non-volatile memory containing software (e.g., firmware, such as BIOS) that is used for reading other software stored in memory device(s) 912 into main memory 914. In some embodiments, the volatile memory of main memory 914 is implemented as RAM, such as dynamic random-access memory (DRAM), and the non-volatile memory of main memory 914 is implemented as read-only memory (ROM), such as flash memory, erasable programmable read-only memory (EPROM), or electrically erasable programmable read-only memory (EEPROM).

Computer system 900 may include software elements, shown as being currently located within main memory 914, which may include an operating system, device driver(s), firmware, compilers, and/or other code, such as one or more application programs, which may include computer programs provided by various embodiments of the present disclosure. Merely by way of example, one or more steps described with respect to any methods discussed above, may be implemented as instructions 916, which are executable by computer system 900. In one example, such instructions 916 may be received by computer system 900 using communications subsystem 910 (e.g., via a wireless or wired signal that carries instructions 916), carried by communication medium 902 to memory device(s) 912, stored within memory device(s) 912, read into main memory 914, and executed by processor(s) 904 to perform one or more steps of the described methods. In another example, instructions 916 may be received by computer system 900 using input device(s) 906 (e.g., via a reader for removable media), carried by communication medium 902 to memory device(s) 912, stored within memory device(s) 912, read into main memory 914, and executed by processor(s) 904 to perform one or more steps of the described methods.

Computer system 900 may include optional wireless communication components that facilitate wireless communication over a voice network and/or a data network. The wireless communication components comprise an antenna system 924, a radio system 922, and a baseband system 920. In computer system 900, RF signals are transmitted and received over the air by antenna system 924 under the management of radio system 922. In an embodiment, antenna system 924 may comprise one or more antennae and one or more multiplexors (not shown) that perform a switching function to provide antenna system 924 with transmit and receive signal paths. In the reception path, received RF signals can be coupled from a multiplexor to a low noise amplifier (not shown) that amplifies the received RF signal and sends the amplified signal to radio system 922. In an alternative embodiment, radio system 922 may comprise one or more radios that are configured to communicate over various frequencies. In an embodiment, radio system 922 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 922 to baseband system 920.

In some embodiments of the present disclosure, instructions 916 are stored on a computer-readable storage medium (or simply computer-readable medium). Such a computer-readable medium may be non-transitory and may therefore be referred to as a non-transitory computer-readable medium. In some cases, the non-transitory computer-readable medium may be incorporated within computer system 900. For example, the non-transitory computer-readable medium may be one of memory device(s) 912 (as shown in FIG. 9). In some cases, the non-transitory computer-readable medium may be separate from computer system 900. In one example, the non-transitory computer-readable medium may be a removable medium provided to input device(s) 906 (as shown in FIG. 9), such as those described in reference to input device(s) 906, with instructions 916 being read into computer system 900 by input device(s) 906. In another example, the non-transitory computer-readable medium may be a component of a remote electronic device, such as a mobile phone, that may wirelessly transmit a data signal that carries instructions 916 to computer system 900 and that is received by communications subsystem 910 (as shown in FIG. 9).

Instructions 916 may take any suitable form to be read and/or executed by computer system 900. For example, instructions 916 may be source code (written in a human-readable programming language such as Java, C, C++, C#, Python), object code, assembly language, machine code, microcode, executable code, and/or the like. In one example, instructions 916 are provided to computer system 900 in the form of source code, and a compiler is used to translate instructions 916 from source code to machine code, which may then be read into main memory 914 for execution by processor(s) 904. As another example, instructions 916 are provided to computer system 900 in the form of an executable file with machine code that may immediately be read into main memory 914 for execution by processor(s) 904. In various examples, instructions 916 may be provided to computer system 900 in encrypted or unencrypted form, compressed or uncompressed form, as an installation package or an initialization for a broader software deployment, among other possibilities.

In one aspect of the present disclosure, a system (e.g., computer system 900) is provided to perform methods in accordance with various embodiments of the present disclosure. For example, some embodiments may include a system comprising one or more processors (e.g., processor(s) 904) that are communicatively coupled to a non-transitory computer-readable medium (e.g., memory device(s) 912 or main memory 914). The non-transitory computer-readable medium may have instructions (e.g., instructions 916) stored therein that, when executed by the one or more processors, cause the one or more processors to perform the methods described in the various embodiments.

In another aspect of the present disclosure, a computer-program product that includes instructions (e.g., instructions 916) is provided to perform methods in accordance with various embodiments of the present disclosure. The computer-program product may be tangibly embodied in a non-transitory computer-readable medium (e.g., memory device(s) 912 or main memory 914). The instructions may be configured to cause one or more processors (e.g., processor(s) 904) to perform the methods described in the various embodiments.

In another aspect of the present disclosure, a non-transitory computer-readable medium (e.g., memory device(s) 912 or main memory 914) is provided. The non-transitory computer-readable medium may have instructions (e.g., instructions 916) stored therein that, when executed by one or more processors (e.g., processor(s) 904), cause the one or more processors to perform the methods described in the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of assigning a set of workloads to compute nodes in a compute infrastructure, the method comprising:
receiving, at a workload scheduler, the set of workloads to be run on the compute nodes, each workload of the set of workloads having a workload specification indicating requested resources to run the workload;
generating, by a set of server agents running on a set of servers containing the compute nodes, server statuses indicating resource usages and availabilities at the compute nodes;
sending the server statuses from the set of server agents to the workload scheduler;
generating, by the workload scheduler, server assignments for the set of workloads based on the requested resources and the resource usages and availabilities;
generating, by one or more of the set of server agents, compute node assignments for the set of workloads based on the requested resources and the resource usages and availabilities; and
running the set of workloads on the compute nodes in accordance with the server assignments and the compute node assignments.

2. The method of claim 1, wherein the workload specification indicates at least one of:
a processor request indicating a number of processors or cores requested for the workload;
a memory request indicating an amount of memory requested for the workload;
a network interface card (NIC) bandwidth request indicating an amount of NIC bandwidth requested for the workload; or
a memory bandwidth memory request indicating an amount of memory bandwidth requested for the workload.

3. The method of claim 1, wherein each of the server statuses indicates at least one of:
a processor availability at a compute node of a corresponding server;
a memory availability at the compute node;
a network interface card (NIC) bandwidth availability at the compute node; or
a memory bandwidth availability at the compute node.

4. The method of claim 1, wherein the workload specification indicates a grouping ID, wherein workloads having a same grouping ID are attempted to be assigned to a same compute node.

5. The method of claim 1, wherein:
generating the server assignments for the set of workloads includes assigning a first workload, a second workload, and a third workload of the set of workloads to a first server of the set of servers;
generating the compute node assignments for the set of workloads includes assigning the first workload and the second workload to a first compute node of the first server and assigning the third workload to a second compute node of the first server; and
the workload specification for each of the first workload, the second workload, and the third workload indicates a same grouping ID.

6. The method of claim 1, wherein the set of workloads are virtual network function (VNF) workloads.

7. The method of claim 1, wherein each of the set of servers includes at least two of the compute nodes.

8. The method of claim 1, wherein the compute infrastructure is a cluster consisting of the set of servers.

9. A non-transitory computer-readable medium comprising instructions that, when executed by one or more processors, cause the one or more processors to perform operations for assigning a set of workloads to compute nodes in a compute infrastructure, the operations comprising:
receiving, at a workload scheduler, the set of workloads to be run on the compute nodes, each workload of the set of workloads having a workload specification indicating requested resources to run the workload;
generating, by a set of server agents running on a set of servers containing the compute nodes, server statuses indicating resource usages and availabilities at the compute nodes;
sending the server statuses from the set of server agents to the workload scheduler;
generating, by the workload scheduler, server assignments for the set of workloads based on the requested resources and the resource usages and availabilities;
generating, by one or more of the set of server agents, compute node assignments for the set of workloads based on the requested resources and the resource usages and availabilities; and
running the set of workloads on the compute nodes in accordance with the server assignments and the compute node assignments.

10. The non-transitory computer-readable medium of claim 9, wherein the workload specification indicates at least one of:
a processor request indicating a number of processors or cores requested for the workload;
a memory request indicating an amount of memory requested for the workload;
a network interface card (NIC) bandwidth request indicating an amount of NIC bandwidth requested for the workload; or
a memory bandwidth memory request indicating an amount of memory bandwidth requested for the workload.

11. The non-transitory computer-readable medium of claim 9, wherein each of the server statuses indicates at least one of:
a processor availability at a compute node of a corresponding server;
a memory availability at the compute node;
a network interface card (NIC) bandwidth availability at the compute node; or
a memory bandwidth availability at the compute node.

12. The non-transitory computer-readable medium of claim 9, wherein the workload specification indicates a grouping ID, wherein workloads having a same grouping ID are attempted to be assigned to a same compute node.

13. The non-transitory computer-readable medium of claim 9, wherein:
generating the server assignments for the set of workloads includes assigning a first workload, a second workload, and a third workload of the set of workloads to a first server of the set of servers;
generating the compute node assignments for the set of workloads includes assigning the first workload and the second workload to a first compute node of the first server and assigning the third workload to a second compute node of the first server; and
the workload specification for each of the first workload, the second workload, and the third workload indicates a same grouping ID.

14. The non-transitory computer-readable medium of claim 9, wherein the set of workloads are virtual network function (VNF) workloads.

15. A system comprising:
one or more processors; and
a computer-readable medium comprising instructions that, when executed by the one or more processors, cause the one or more processors to perform operations for assigning a set of workloads to compute nodes in a compute infrastructure, the operations comprising:
receiving, at a workload scheduler, the set of workloads to be run on the compute nodes, each workload of the set of workloads having a workload specification indicating requested resources to run the workload;
generating, by a set of server agents running on a set of servers containing the compute nodes, server statuses indicating resource usages and availabilities at the compute nodes;
sending the server statuses from the set of server agents to the workload scheduler;
generating, by the workload scheduler, server assignments for the set of workloads based on the requested resources and the resource usages and availabilities;
generating, by one or more of the set of server agents, compute node assignments for the set of workloads based on the requested resources and the resource usages and availabilities; and
running the set of workloads on the compute nodes in accordance with the server assignments and the compute node assignments.

16. The system of claim 15, wherein the workload specification indicates at least one of:
a processor request indicating a number of processors or cores requested for the workload;
a memory request indicating an amount of memory requested for the workload;
a network interface card (NIC) bandwidth request indicating an amount of NIC bandwidth requested for the workload; or
a memory bandwidth memory request indicating an amount of memory bandwidth requested for the workload.

17. The system of claim 15, wherein each of the server statuses indicates at least one of:
a processor availability at a compute node of a corresponding server;
a memory availability at the compute node;
a network interface card (NIC) bandwidth availability at the compute node; or
a memory bandwidth availability at the compute node.

18. The system of claim 15, wherein the workload specification indicates a grouping ID, wherein workloads having a same grouping ID are attempted to be assigned to a same compute node.

19. The system of claim 15, wherein:
generating the server assignments for the set of workloads includes assigning a first workload, a second workload, and a third workload of the set of workloads to a first server of the set of servers;
generating the compute node assignments for the set of workloads includes assigning the first workload and the second workload to a first compute node of the first server and assigning the third workload to a second compute node of the first server; and
the workload specification for each of the first workload, the second workload, and the third workload indicates a same grouping ID.

20. The system of claim 15, wherein the set of workloads are virtual network function (VNF) workloads.
